(19) United States
(12) Patent Application Publication
(10) Pub. No.: US 2008/0026765 A1
(43) Pub. Date: Jan. 31, 2008

(54) Tool for Multi-Technology Distributed Antenna Systems

(76) Inventor: Hugo Charbonneau, St-Laurent (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/837,223

(22) Filed: Aug. 10, 2007

Related U.S. Application Data
(63) Continuation-in-part of application No. 10/744,018, filed on Dec. 24, 2003, now abandoned.

(51) Int. Cl. H04Q 7/20

(52) U.S. Cl. 455/446

(57) ABSTRACT

A computer-implemented design tool is disclosed for designing a multi-technology wireless Distributed Antenna Systems (DAS) network. The design tool allows a wireless designer to select antennas, network components, cable elements and signal sources from one or more databases and to place them on a design screen. The design tool is particularly configured to create DAS network adapted to support several signal sources, each signal source generally using a different band of frequencies and/or a different wireless network communication technology. In addition, the design tool performs multiple simultaneous complex RF calculations in uplink and/or downlink direction for each signal source and further displays the results of these calculations at each interconnection of the DAS network. The design tool also updates all the RF calculations when the network design is modified by the designer. Hence, by performing and updating RF calculations for several bands of frequencies and several communication technologies, the design tool allows the designer to rapidly correct the flaws in his design in order to rapidly obtain an adequate network design.

### CROSS-REFERENCE TO RELATED APPLICATIONS

The present patent application is a continuation-in-part of commonly assigned U.S. patent application Ser. No. 10/744,018, now abandoned, and claims the benefits of priority thereof. The disclosure of U.S. patent application Ser. No. 10/744,018 is incorporated herein by reference.

### FIELD OF THE INVENTION

The present invention generally relates to wireless communications networks, and more particularly to a system and method for designing wireless communications networks.

### BACKGROUND OF THE INVENTION

Mobile communications devices, such as cellular telephones, pagers and the like, are now commonplace and are now being used more indoor than in vehicles. With the new form factor of cellular phones and the growing demand for wireless data services, the mobile traffic has shifted from outdoors to indoors, where typically radio-frequency (RF) penetration is often limited. To maximize ARPU (Average Revenues Per Users), reduce the percentage number of deactivations (CHURN), and maintain customer satisfaction, wireless operators have to optimize their network and do RF deployment inside buildings using state-of-the-art technologies to improve coverage, data throughput and capacity. Indoor RF design is generally very complex, especially nowadays with the advent of multi-operators and multi-technologies that are requested by the building's owners. These systems can cause serious deterioration of the network if they are not engineered correctly. Moreover, wireless operators may suffer from a lack of knowledge and expertise and may not take full advantage of their indoor networks.

In order to assist wireless network engineers in developing and designing indoor wireless networks, numerous computerized methods, systems and/or softwares have been proposed to address the problems of indoor network design. However, the main focus of these design tools generally revolves around propagation prediction, which is not adequate for efficient network design.

Some of the aforementioned computerized methods and softwares have been disclosed in patents, some of which are listed hereinbelow:

U.S. Pat. No. 6,625,454, issued Sep. 23, 2003, to Rappaport et al. for “Method and System for Designing or Deploying a Communications Network which Considers Frequency Dependent Effects”;

U.S. Pat. No. 6,317,599, issued Nov. 13, 2001, to Rappaport et al. for “Method and System for Automated Optimization of Antenna in 3-D”;

U.S. Pat. No. 6,119,009, issued Sep. 12, 2000, to Baranger et al. for “Method and Apparatus for Modeling the Propagation of Wireless Signals in Buildings”.

The aforesaid design tools, however, perform only the prediction part of a network design. Moreover, the aforesaid design tools are only predicting the coverage between the antennas and the mobiles without taking into account the distributed antenna system (DAS) network that interfaces the base stations with those antennas. Another important limitation of those tools is that they are predicting only one band of frequency at the time which is not reflecting today's requirements. Furthermore, other separate home made solution running in software tools such as Excel™ and Visio™ are often required to perform subsequent design operations such as the antenna distribution. These methods tend to be error prone, complicated and not standard from one designer to another.

There is thus a need for an improved computer-assisted network design tool for designing the network portion between the base stations and the remote antenna also called “Distributed Antenna System” (hereinafter “DAS”) network.

### OBJECTS OF THE INVENTION

Accordingly, one of the main aspects of the present invention is to provide a computerized design tool for designing DAS networks wherein the computerized design tool simultaneously support multiple sources of signals, each of which having a different band of frequencies and/or a different communication technology.

Another important aspect of the present invention is to provide a computerized design tool for designing DAS networks wherein the computerized design tool is able to execute simultaneous complex RF calculations in the uplink and/or downlink directions for each selected band of frequencies and for each selected communication technology.

Still another aspect of the present invention is to provide a computerized design tool for designing DAS networks wherein the RF calculations are based on the real physical, electrical and mechanical specifications of the antennas, network components, cables and signal sources comprised in the DAS network.

Yet another aspect of the present invention is to provide a computerized design tool for designing DAS networks which provides substantially real-time validation of the design and which also provide substantially automatic troubleshooting.

Yet another aspect of the present invention is to provide a computerized design tool for designing DAS networks which provides graphical and schematic views of the designed DAS network.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

The aforesaid and other objectives of the present invention are realized by generally providing a novel design tool for designing distributed antenna systems (DAS) networks. As mentioned above, a DAS network is generally the portion of the network between the signal sources (i.e. the base stations) and the remote antennas. Since different signal sources can use different communication technologies and/or different bands of frequencies, it is important for a modem DAS network to support all the technologies and/or bands of frequencies of the signal sources to which it is connected. Hence, the design tool of the present invention is adapted to do simultaneous complex RF calculations in the uplink and/or downlink direction for all the defined signal sources to which the DAS network is connected. The present invention reduces the difficulties and disadvantages of the prior art by providing a design tool which enables the wireless designers to use one common tool to design and select the right components, evaluate and adjust a wireless DAS network.

The design tool of the present invention is generally, but not exclusively, embodied as a computerized method stored as computer-readable instructions on a data storage media and executed on a state-of-the-art computer system or other similar data processing devices.

Thus, the present design tool allows the wireless designer to define the signal sources which the DAS network will have to support. Being essentially a computer-aided design tool, the definition of the signal sources is preferably effected through menus and input windows into which the specific parameters of each signal source are entered. Once all the signal sources are defined, the wireless designer can start designing the DAS network.

To do so, the present design tool allows the wireless designer to select all the necessary antennas and network components (e.g. amplifiers, splitters, connectors, etc.) from one or more databases stored on the computer system and to incorporate these selected antennas and network components in a design window via a user-friendly drag-and-drop technique. Understandably, the design window is displayed on a display device such as, but not limited to, an electronic display screen, and the drag-and-drop technique is done via an appropriate pointing device such as, but not limited to, a mouse. Once the selected antennas and network components are disposed on the design window, the wireless designers can link, with the pointing device, the selected antennas and network components with cable elements (e.g. coaxial, twisted pairs, optical fiber, etc.) selected from a cable database, also provided with the design tool and stored on the computer system. The antenna, network component and cable databases are preferably accessible via on-screen windows, menus and/or buttons though they can be accessible otherwise. Understandably, the databases can be common or combined into a single part database. The present invention is not limited to one or more than one databases.

It is to be noted that at any time, the wireless designer can move, add, remove and/or change one or more antennas, network components and/or cable elements in the design window. The designing of a DAS network does not need to be a linear process.

According to the invention, in order to provide a realistic and useful DAS network design, the antenna, network component and cable databases of the present design tool comprise all the physical, electrical and mechanical specifications and/or parameters of each antenna, each component and each cable element listed therein. Hence, during the calculation phase, the RF calculations effected by the design tool will take into account the real behaviour of each antenna, each network component and each cable element.

The design tool of the present invention is used to design a DAS network which will have to support several signal sources, each of which possibly having a different communication technology (e.g. GSM, CDMA, EDGE, GPRS, iDEN, TDMA, HSDPA, WCDMA, 1xEV-DO, TD-SCDMA, 802.11 a/b/g, 802.16 e, etc.) and/or using a different frequency band (e.g. VHF, UHF, Tetra, 450 MHz, Paging, Public Safety 700, SMR800-900, GSM900, DCS1800, UMTS2100, Cellular850, PCS1900, AWS2100, WiFi 2400-5800, WiMAX 2300-2500-3500-5800, ISM, etc.). Hence, the design tool is adapted to simultaneously perform several types of uplink and/or downlink RF calculations (e.g. link budget, pilot power, etc.) for each signal source and thus, for each frequency band and/or for each technology.

The results of these calculations are simultaneously displayed at each interconnection of each antenna and each network component present on the design window, thereby significantly reducing design errors and enabling DAS components' incompatibilities to be detected and corrected rapidly. Additionally, the design tool advantageously comprises a debug message window into which all the components' incompatibilities are listed, thereby allowing the wireless designer to see at a glance which antenna and/or network component and/or cable element are incompatible for certain bands of frequencies and/or for certain technologies.

Being an iterative process, the design of the DAS network can comprise several iterations during which the wireless designer can add, remove, and/or change certain antennas, certain components and/or certain cable elements in order to render the DAS network fully compatible with all the signal sources. According to the invention, each modification made to any one of the antennas, network components, cable elements or sources of signal of the design is automatically taken into account by the design tool which automatically updates the RF uplink and/or downlink calculations in order to reflect the modifications.

In order to enhance the design process, the design screen of the design tool preferably provides graphical and schematic views of the design. These detailed graphical and schematic views advantageously improve the design process by increasing the understanding of the disposition of each antenna, each network component, each cable element and each source of signals of the DAS and the relation between them.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a screenshot view of the design screen of the present invention;

FIG. 2 is a zoomed-in screenshot view of a portion of the design screen of FIG. 1 showing the calculation legend;

FIG. 3 is a zoomed-in screenshot view of another portion of the design screen of FIG. 1 showing uplink and downlink calculations;

FIG. 4 is a screenshot view of an example of a selection window for an antenna;

FIG. 5 is a screenshot view of an example of a selection window for an amplifier;

FIG. 6 is a screenshot view of an example of a selection window for a splitter;

FIG. 7 is a screenshot view of an example of a selection window for a type cable;

FIG. 8 is a screenshot view of an example of a selection window for another type of cable;

FIG. 9 is a screenshot view of an example of a first parameters input window for a signal source;

FIG. 10 is a screenshot view of an example of a second parameters input window for a signal source;

FIG. 11 is a screenshot view of an example of a third parameters input window for a signal source;

FIG. 12 is a screenshot view of an example of a fourth parameters input window for a signal source;

FIG. 13 is a zoomed-in screenshot view of a design screen showing a first antenna and the uplink and downlink calculations related thereto, before the replacement;

FIG. 14 is a zoomed-in screenshot view of a design screen showing a component windows during the replacement of the antenna of FIG. 13;

FIG. 15 is a zoomed-in screenshot view of a design screen showing a second antenna and the updated uplink and downlink calculations related thereto, after the replacement;

### DETAILED DESCRIPTION OF THE PREFERRED EMBODIMENTS

A novel design tool for multi-technology distributed antenna systems will be described hereinafter. Although the invention is described in terms of specific illustrative embodiments, it is to be understood that the embodiments described herein are by way of example only and that the scope of the invention is not intended to be limited thereby.

In a nutshell, the design tool of the present invention allows the wireless designer to devise a DAS network which can support multiple signal sources, each of them possibly using a different band of frequencies and/or a different communication technology. Moreover, for each compatible signal source present in the design, the design tool substantially simultaneously computes uplink and downlink values at each antenna and each network component interconnection. Also, the design tool updates any uplink and/or downlink calculations which may have been affected by a modification in the design.

Being a computer-aided design (CAD) tool, the present invention is generally embodied as a computerized method supported by a state-of-the-art computer system, the kind of which is generally known in the art.

To assist the wireless designer in designing a DAS network, the design tool of the present invention provides the designer with a design screen, displayed on a display system (e.g. CRT screen, LCD screen, etc.) which can be interfaced with a pointing device (e.g. mouse, trackball, stylus, etc.) and a keyboard or other similar data input device. However, the present invention is not so limited.

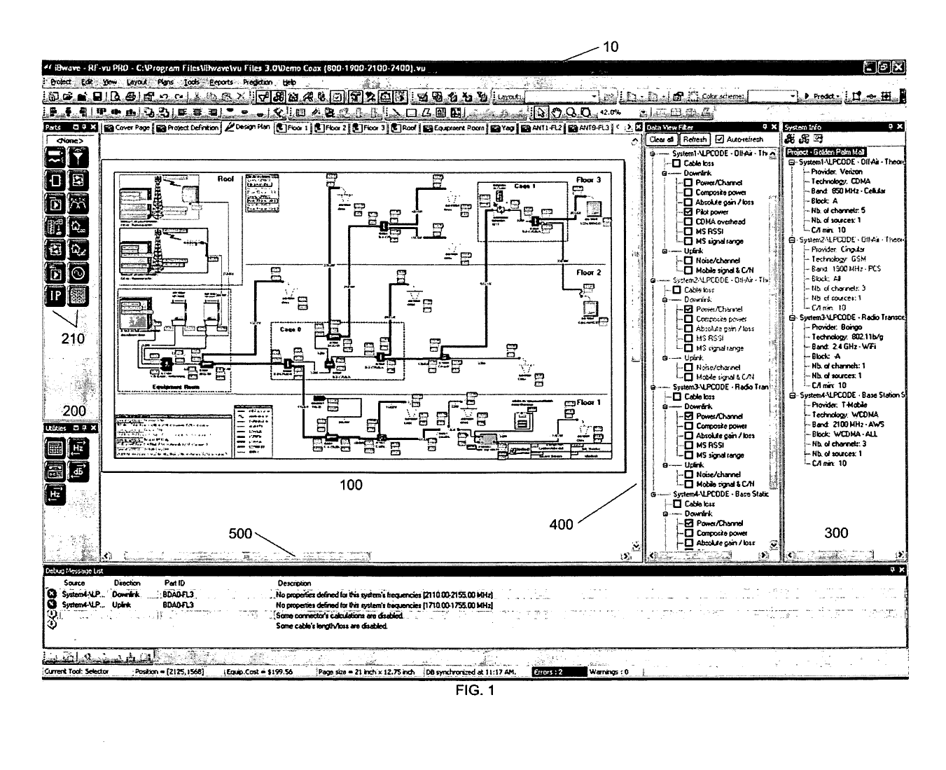

Hence, referring first to FIG. 1, an illustrative overall screenshot of the design screen 10 of the present invention is shown. As shown in FIG. 1, the design screen can comprise a plurality of windows 100, 200, 300, 400 and 500, each of which having a particular utility. The number of windows shown in FIG. 1 should however not be seen as limitative in any way.

The main window of the design screen 10 is the design window 100. The design window 100 is understandably the window into which the different parts (i.e. antennas, network components, cable elements and signal sources) of the DAS network will be added and schematically disposed. Hence, the design window 100 allows the designer to add parts, displace them, erase them and/or modify them according to the need of the DAS network design.

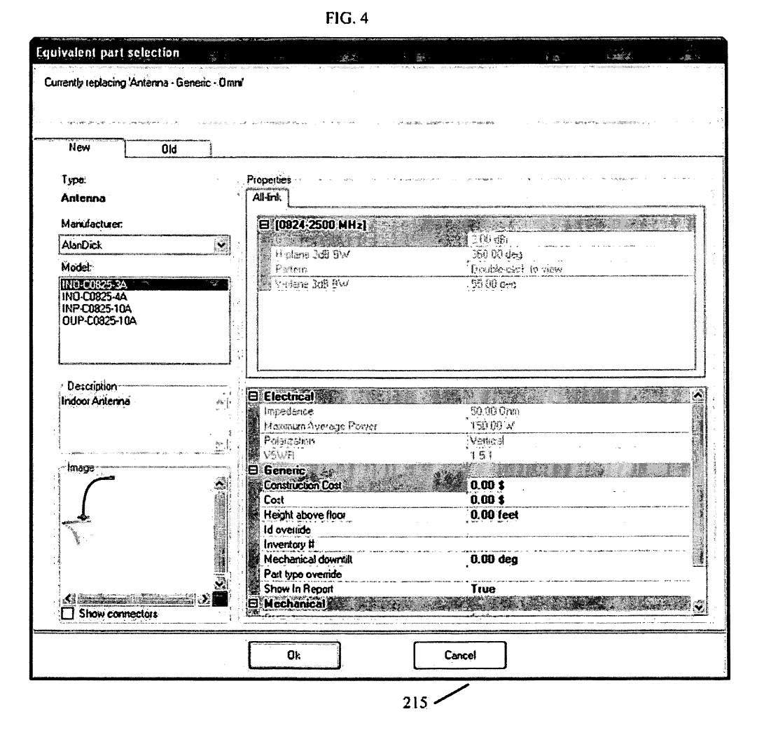

In order to add parts into the design window, the design screen 10 also comprises a part window 200 which is linked to the part database or databases stored on the computer system. In the present invention, the part window 200 comprises several buttons 210, each button 210 being linked to a different type of parts. Depending on the particular type of parts which the designer wants to add to the design window 100, different part selection windows 215 will appear upon clicking on a particular part type button 210. Examples of such part selection windows 215 are shown in FIGS. 4 to 8.

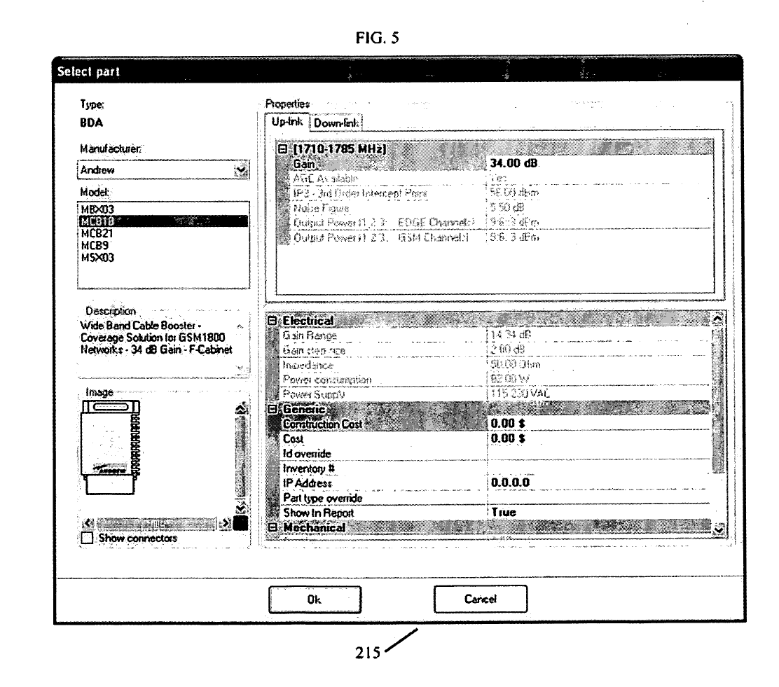

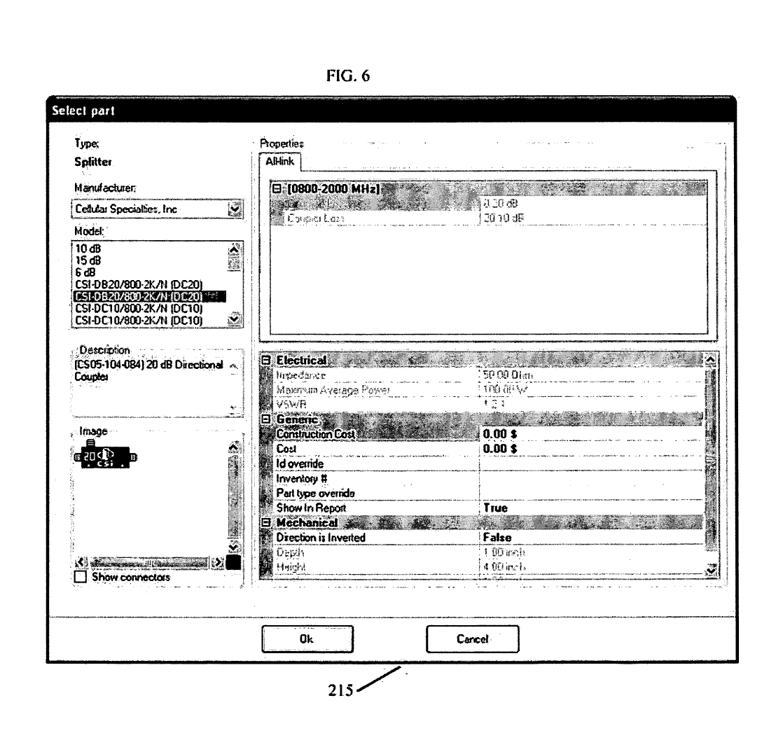

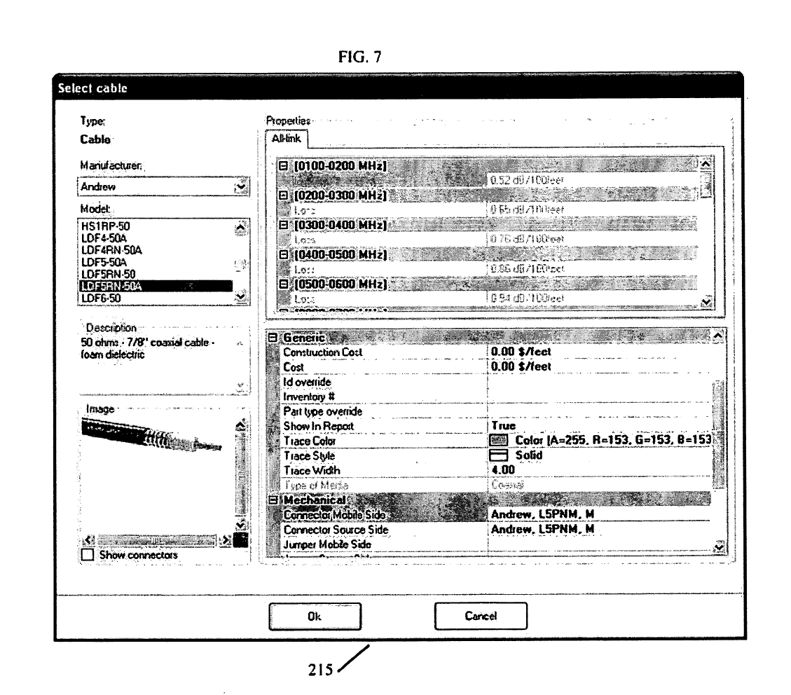

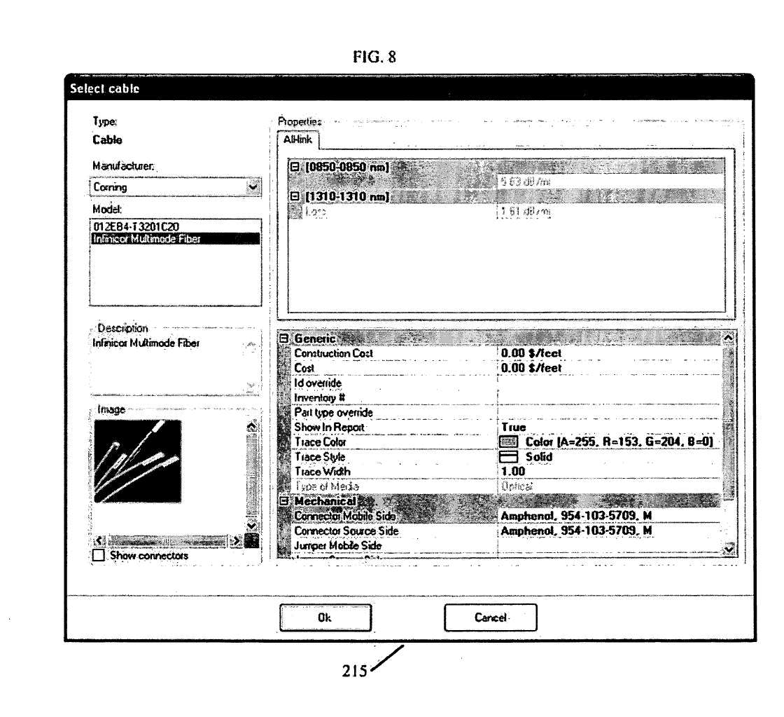

More particularly, FIG. 4 shows an antenna selection window, FIG. 5 shows an amplifier selection window, FIG. 6 shows a splitter selection window, FIG. 7 shows a first cable element selection window and FIG. 8 shows a second cable element selection window.

According to the present invention, the electrical, physical, mechanical and/or other generic parameters and specifications of each available part is preferably stored in the part database which is preferably stored on the computer system. These parameters and specifications are displayed in the part selection windows 215. However, as the skilled addressee would understand, the information displayed in each part selection window 215 will vary according to the selected part. Hence, the parameters and specifications shown for an antenna will generally differ from the parameters and specifications shown for a cable element. Still, each part selection window 215 generally allows the designer to select a specific part manufacturer and a specific part model.

Still referring to FIG. 1, the design screen also preferably comprises a signal source information window 300 (identified as “System Info” in FIG. 1). The signal source information window 300 displays, for each signal source present in a particular DAS network design, all the relevant signal source parameters such as the signal provider, the communication technology, the frequency band, the number of channels, etc. Understandably, the number of parameters effectively displayed will vary according to the needs of the design tool and according to the specific technology of the signal source.

The design screen also comprises a data selection window 400 (identified as “Data View Filter” in FIG. 1). As the skilled addressee will understand, the data selection window 400 is closely related to the signal source information window 300. Indeed, all the signal sources listed in the signal source information window 300 are also listed in the data selection window 400. However, whereas the signal source information window 300 only displays signal source information, the data selection window 400 allows the wireless design to select which RF parameter or parameters will be computed for each signal source. For example, in the data selection window 400 shown in FIG. 1, for the signal source 1 (identified as “System1”), the selected RF parameter to be calculated is the pilot power in the downlink direction whereas for the signal source 2 (identified as “System2”), the selected RF parameter to be calculated is the power/channel ratio in the downlink direction. As the skilled addressee would understand, more than one RF parameter could be selected if needed; the invention is not so limited.

Finally, the design screen 10 advantageously comprises a debug message window 500 which lists all the compatibility errors present in the DAS network design. According to the present invention, the debug message window 500 preferably indicates the signal source involved in the compatibility error, the direction (i.e. uplink or downlink), the specific part involved and a short description of the error. For example, in the debug message window 500 shown in the design screen 10 of FIG. 1, the first listed error indicates that the part identified as “BDA0-FL3” does not support the 2110-2155 MHz frequency band, associated with the signal source 4 (identified as “System4”) in the downlink direction. The debug message window 500 thereby allows the wireless designer to rapidly spot compatibility error in the DAS network and take appropriate action to remove the incompatibility.

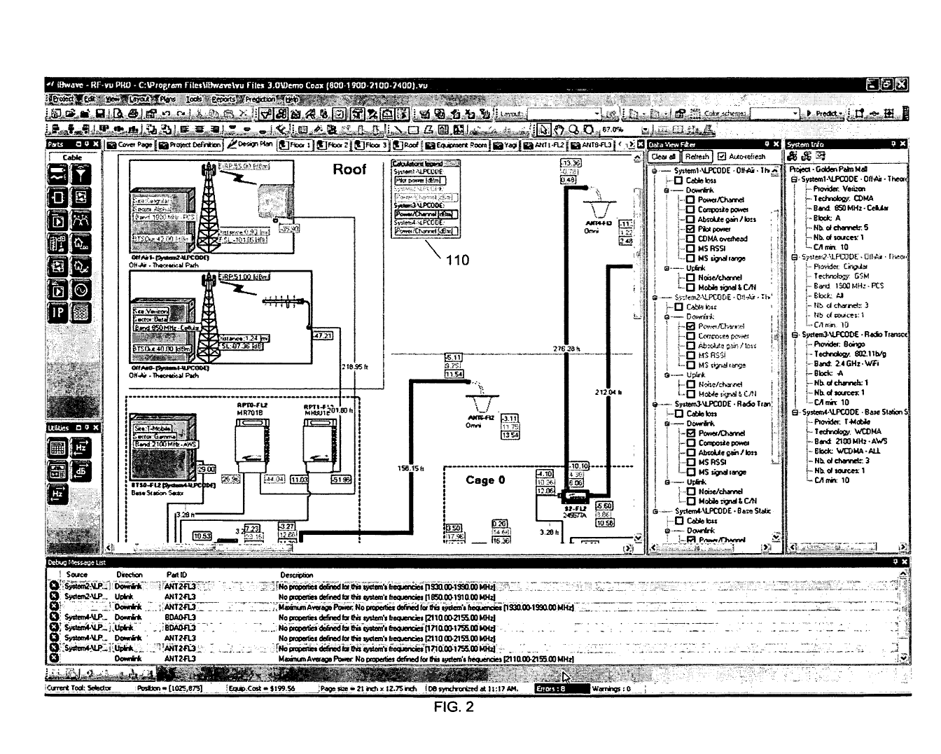

Referring now to FIG. 2, in addition to all the network parts displayed therein, the design window 100 preferably further comprises a signal source calculation legend 110 which lists, for all the signal sources present in the design and defined in the signal source information window 300, the RF parameter or parameters that will be computed. For example, as shown in FIG. 2, for the signal source “System1” defined in the signal source information window 300, the calculated RF parameter will be the “Pilot power”, as selected in the data selection window 400.

In addition to listing the calculated parameter or parameters, the calculation legend 110 displays each signal source with a different color. Preferably, the color used to differentiate the signal sources in the calculation legend 110 are also used to differentiate each signal source in the signal source information window 300 and in the data selection window 400. As the results of the calculation are displayed in the design window 100, the results associated with a particular signal source will be displayed with the same color as the color assigned to a particular signal source. Thus, at a glance, the wireless designer will be able to rapidly distinguish the results of the calculations for a particular signal source.

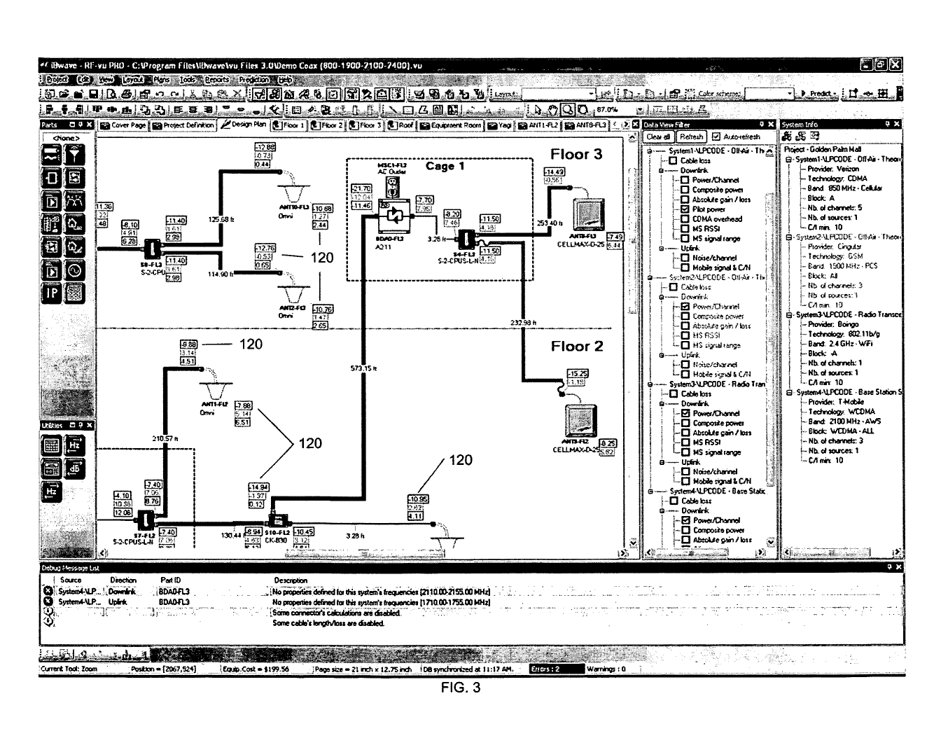

Additionally, as best shown in FIG. 3, the results 120 of the calculations are displayed at each interconnection present in the design. More particularly, according to the preferred embodiment, the results are displayed in boxes near the interconnection and vertically sorted according to their definition order. Hence, starting from the top, the first box generally comprises the result for the calculation of the parameter associated with the first signal source. However, according to the invention, should a signal source be incompatible with a certain antenna, a certain network component and/or a certain cable element, the result of the calculation will generally not be displayed at the interconnection though an error message will generally be displayed in the debug message window 500. In an alternate embodiment, an error symbol (e.g. “error”, “NaN”, “n/a”, etc.) could be displayed at the interconnection if the RF parameter calculations for a certain signal source are impossible or if the part is incompatible.

Thus, once the signal sources are all defined and the RF parameters to be calculated are selected, the results 120 of the calculations will be displayed in the design window 100 in order for the wireless designer to verify if the DAS network design is correct and compatible with all the signal sources. Since each signal source is assigned a different color, the wireless designer can rapidly spot which antenna, network component and/or cable element is incompatible with which signal source or sources.

According to an important aspect of the present invention, all the calculations for the selected parameters are effected substantially simultaneously. Hence, as it be will shown hereinbelow, the design tool will update all the calculations upon any change or modification of the design.

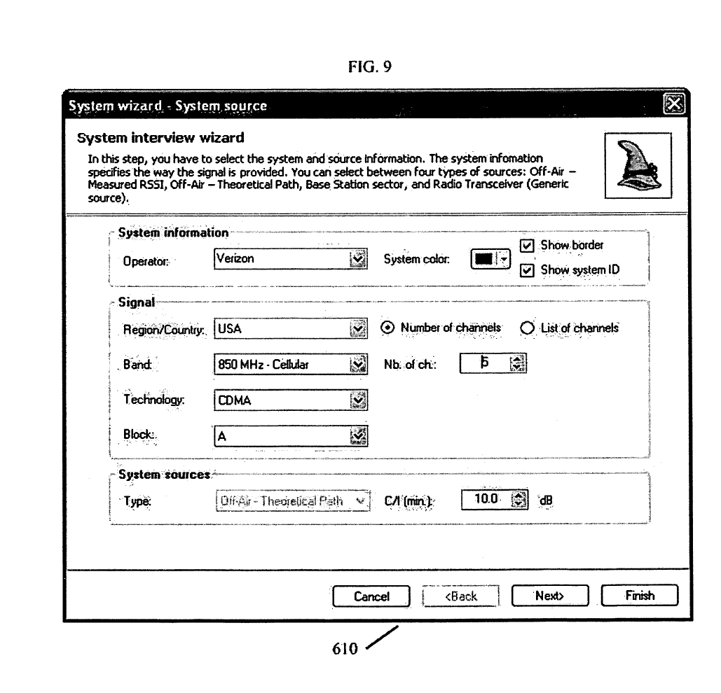

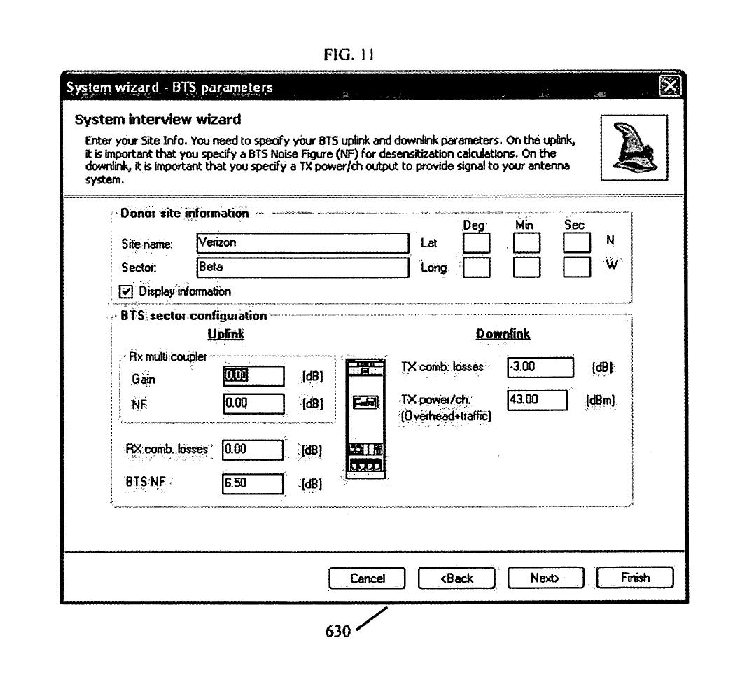

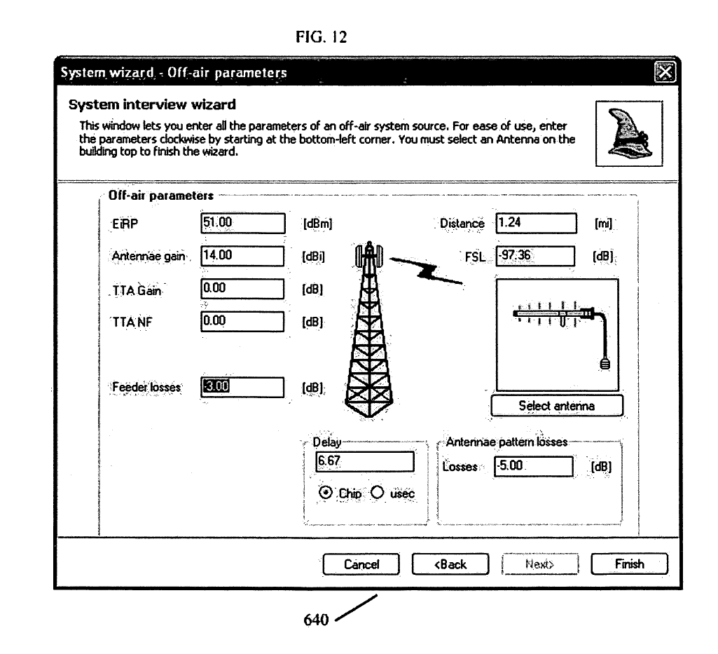

According to the invention, the present design tool is used to design DAS network adapted to support a plurality of communication technologies. However, in order for the design to provide an effective solution for the wireless design, it is of the utmost importance to carefully define each signal source present in the design. To do so, the present design tool allows the wireless designer to precisely determine each parameter of a signal source. FIGS. 9 to 12 show parameters input windows 610, 620, 630 and 640 according to a preferred though not limitative sequence in which the parameters of the signal source are entered.

Initially, in the first input window 610, as shown in FIG. 9, the basic parameters of the signal source are entered. Hence, parameters such as the operator or carrier of the signal source, the assigned color of the signal source, the country in which the signal source is used, the frequency band and the technology are entered. Other parameters can also be entered.

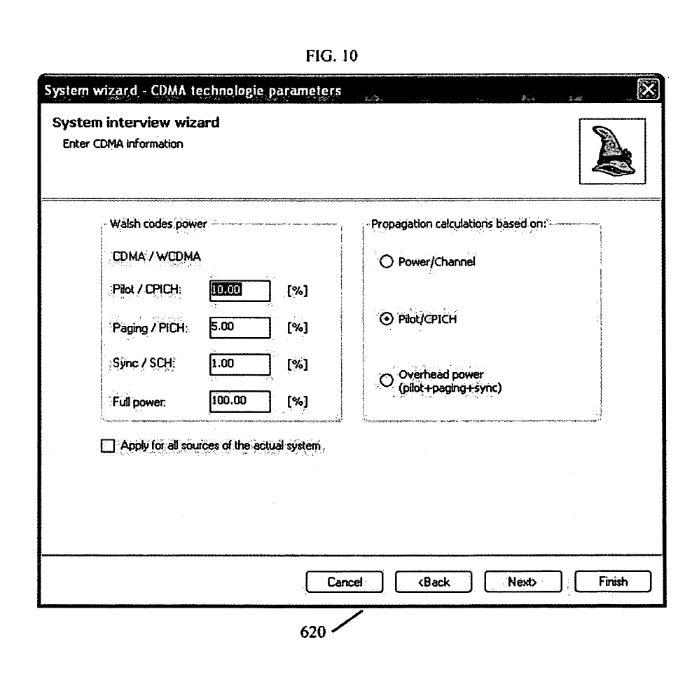

Then, in subsequent input windows 620, 630 and 640 as shown in FIGS. 10, 11 and 12, more specific parameters of the signal source are entered. As the skilled addressee will understand, the parameters which can be entered in the subsequent input windows 620, 630 and 640 will partially vary according to the basic parameters entered in the first input window 610 (i.e. FIG. 9). Hence, if, as shown in the present exemplary sequence, the entered signal source technology is CDMA, then the subsequent input windows 620, 630 and 640 will take this entry into account and will proposed certain parameters which are specific to the CDMA technology. Thus, as shown in FIG. 10, the wireless designer can enter parameters which are specific for the CDMA/WCDMA technology which was entered in the input window 610 of FIG. 9.

Though four input windows 610, 620, 630 and 640 are shown in FIGS. 9 to 12, the sequence could comprise more or less than four input windows, the present invention is not so limited.

As mentioned hereinabove, one of the main aspects of the present invention is the substantially simultaneous calculation of all the RF parameters selected in the data selection window 400. Hence, when all the signal sources, the antennas and the network components are connected and upon the selection of one or more RF parameters to be calculated, the design tool will perform, substantially simultaneously, all the necessary calculations and will display the calculated values 120 at each interconnection. The rapid display of all the calculated values for all the signal sources allows the wireless designer to determine if the calculated values of the selected RF parameters are within predetermined ranges which can vary according to each signal source.

However, as already mentioned, it is possible that an antenna or a network component be incompatible with a certain signal source. It those cases, the design window 100 will either not display the result 120 of the calculation or will display an error symbol near the interconnection. Additionally, an error message will be displayed in the debug message window 500.

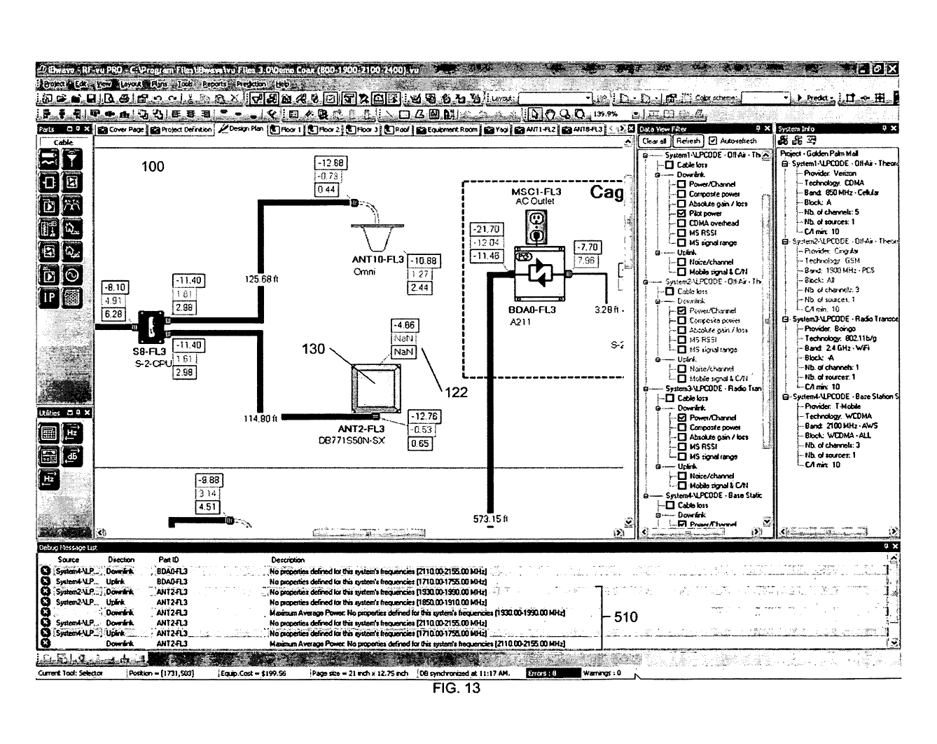

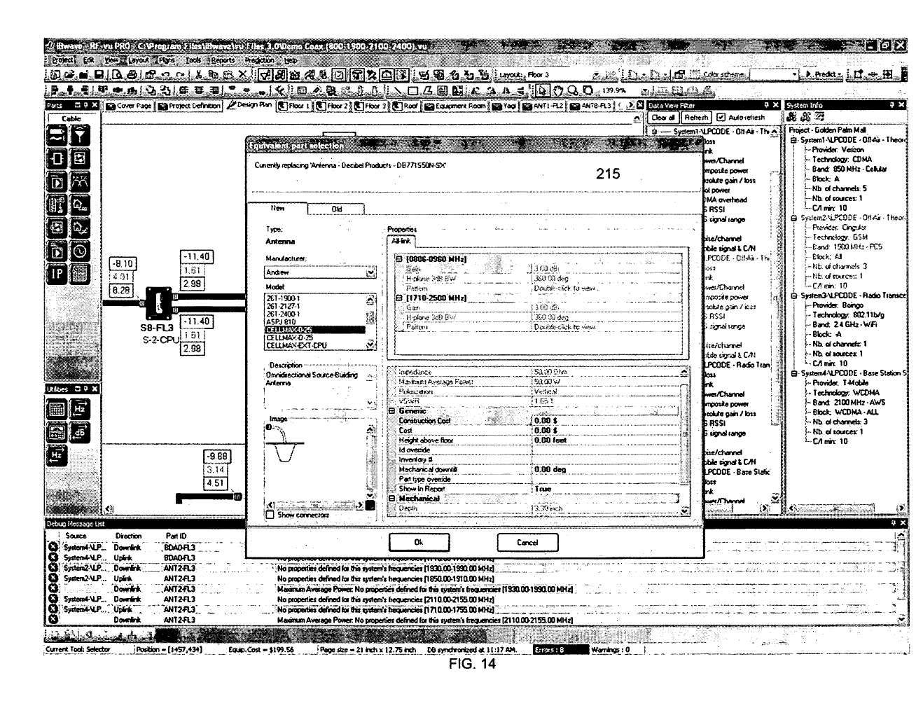

FIGS. 13, 14 and 15 show a network modification sequence and the calculation update resulting therefrom

Beginning in FIG. 13, the design window 100 displays error symbols 122, namely “NaN”, in the color of the second signal source, namely “System2”, and in the color of the fourth signal source, namely “System4”, at the exit of the antenna identified as “ANT2-FL3”, indicating that the antenna 130 “ANT2-FL3” is incompatible with the second and the fourth signal sources. Additionally, corresponding error messages 510 are displayed in the debug message window 500 indicating that the antenna 130 “ANT2-FL3” does not support the frequency band of the second signal source and of the fourth signal source.

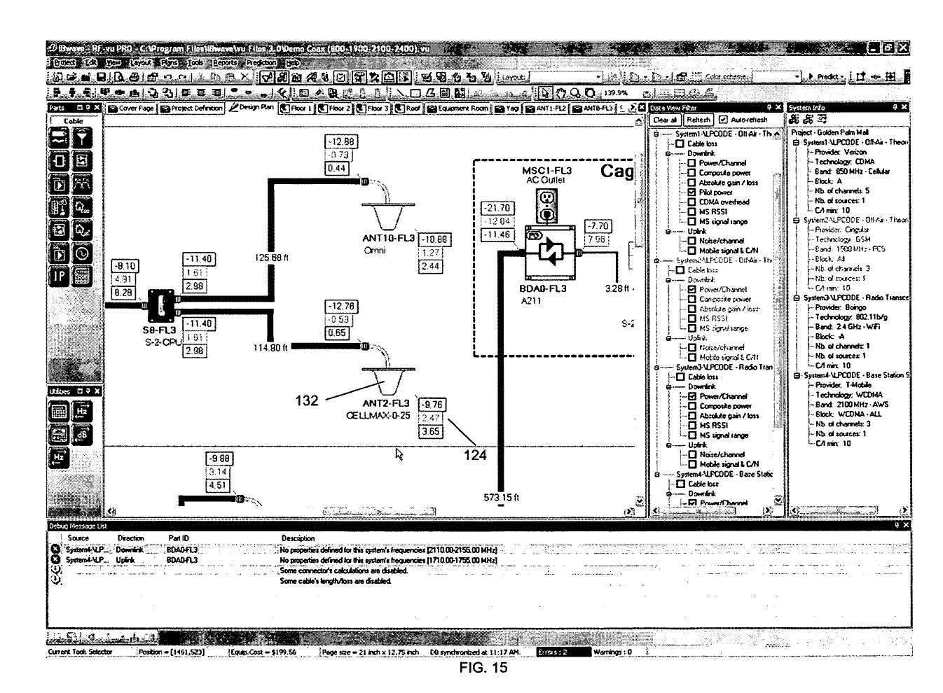

Accordingly, the wireless designer can replace the antenna 130 currently in the design by selecting another antenna 132 from the parts database, using the part window 200. When the wireless designer replaces the current antenna 130, an antenna selection window, similar to the selection window 215 shown in FIG. 4, will appear, allowing the designer to select another antenna. Once selected, the new antenna 132 will replace the former antenna 130 in the design window 100. Substantially simultaneously, the calculations for the RF parameters selected for each signal source will be updated to take into account the new antenna 132. Hence, as shown in FIG. 15, the two error symbols 122 are replaced by the results 124 of the calculations since the new antenna 132 is compatible with both the second and the fourth signal sources. Additionally, the error messages 510 displayed in the debug message window 500 are removed since the new antenna 132 is now compatible with the frequency bands of the second and of the fourth signal sources.

Understandably, the aforementioned sequence can also be used to replace an antenna and/or a network component and/or a cable element which is compatible yet not working within the predetermined ranges of the selected RF parameters for all the signal sources. Generally, the above sequence is repeated until the wireless designer is satisfied that all the antennas, all the network components and all the cable elements of the DAS network are working within the predetermined ranges of the selected RF parameters and are all compatible with the signal sources.

At the end of the design process, when the DAS network designed in fully compatible with all the defined signal sources, the antennas, the components and the cable elements comprised in the DAS network can be used to build and install a working DAS network.

Understandably, the design tool of the present invention is not limited to the embodiment shown in the figures and described hereinabove. Hence, the design tool can further comprise additional windows, buttons and/or menus providing additional information or additional functionalities. Also, the computer system which supports the design tool of the present invention can comprise more or less peripherals according to the needs of the design tool.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A computer-implemented method for designing a distributed antenna system (DAS) network, the method comprising the steps of:
a) defining a plurality of signal sources, each of said signal sources supporting at least a band of frequencies and a communication technology;
b) placing said signal sources in a design window;
c) placing at least one antenna in said design window;
d) placing at least one network component in said design window;
e) interconnecting said signal sources, said at least one network component and said at least one antenna with cable elements;
f) simultaneously verifying the compatibility of said at least one antenna, said at least one network component and said cable elements with all said bands of frequencies and with all said communication technologies of said signal sources;
g) displaying an error message if said at least one antenna and/or said at least one network component and/or said cable elements is incompatible with at least one of said bands of frequencies and/or at least one of said communication technologies of said signal sources;
h) if said at least one antenna is incompatible, replacing said at least one antenna with another antenna;
i) if said at least one network component is incompatible, replacing said at least one network component with another network component;
j) if said cable elements are incompatible, replacing said cable elements with other cable elements;
k) repeating steps f), g), h), i) and j) until said at least one antenna, said at least one network component and said cable elements are all compatible with all said bands of frequencies and all said communication technologies of said signal sources;
whereby said signal sources, said at least one antenna, said at least one network component and said cable elements define said DAS network design.

2) The method as claimed in claim 1, further comprising the step of adding additional network components.

3) The method as claimed in claim 1, further comprising the step of adding additional antennas.

4) The method as claimed in claim 1, wherein said error message is displayed in a debug message window.

5) The method as claimed in claim 1, wherein said error message comprises at least an indication of the signal source involved, an indication of the network component or of the antenna or of the cable element involved and an indication of the nature of the incompatibility.

6) The method as claimed in claim 1, wherein said placing steps and said interconnecting step are effected using an on-screen pointing device.

7) The method as claimed in claim 1, wherein said at least one antenna, said at least one network components and said cable elements are selected from at least one part database.

8) The method as claimed in claim 7, wherein said at least one part database comprises, for each antenna, network component and cable element stored therein, at least one mechanical or physical or electrical parameter.

9) The method as claimed in claim 1, wherein the design window is displayed on a computer display device.

10) A computer-implemented method for designing a distributed antenna system (DAS) network, the method comprising the steps of:
a) defining a plurality of signal sources, each of said signal sources supporting at least a band of frequencies and a communication technology;
b) placing said signal sources in a design window;
c) placing at least one antenna in said design window;
d) placing at least one network component in said design window;
e) interconnecting said signal sources, said at least one network component and said at least one antenna with cable elements;
f) selecting at least one radio-frequency (RF) parameter to be calculated for each of said signal sources;
g) simultaneously performing, for each of said signal sources, calculations to determine the uplink and/or downlink value of said at least one RF parameter at said at least one antenna and at said at least one network component;
h) displaying, for each of said signal sources, said calculated value of said at least one RF parameter at said at least one antenna and at said at least one network component;
i) if, at said at least one antenna, said calculated value of said at least one RF parameter is outside a predetermined range for at least one of said signal sources, replacing said at least one antenna with another antenna;
j) if, at said at least one network component, said calculated value of said at least one RF parameter is outside another predetermined range for at least one of said signal sources, replacing said at least one network component with another network component;
k) repeating steps g), h), i) and j) until said calculated value of said at least one RF parameter at said at least one antenna is within said predetermined range and said calculated value of said at least one RF parameter at said at least one network component is within said another predetermined range, for all of said signal sources; whereby said signal sources, said at least one antenna, said at least one network component and said cable elements define said DAS network design.

11) The method as claimed in claim 10, further comprising the step of adding additional network components.

12) The method as claimed in claim 10, further comprising the step of adding additional antennas.

13) The method as claimed in claim 10, wherein said calculated values are displayed in said design window.

14) The method as claimed in claim 13, wherein said calculated values of said at least one RF parameter for said at least one antenna and said at least one network component are respectively displayed near said at least one antenna and said at least one network component.

15) The method as claimed in claim 14, wherein said calculated values are displayed with a different color for each of said signal sources.

16) The method as claimed in claim 10, wherein said placing steps and said interconnecting step are effected using an on-screen pointing device.

17) The method as claimed in claim 10, wherein said at least one antenna, said at least one network components and said cable elements are selected from at least one part database.

18) The method as claimed in claim 17, wherein said at least one part database comprises, for each antenna, network component and cable element stored therein, at least one mechanical or physical or electrical parameter.

19) The method as claimed in claim 10, wherein the design window is displayed on a computer display device.
